(19) United States
(12) Patent Application Publication
(10) Pub. No.: US 2010/0254126 A1
(43) Pub. Date: Oct. 7, 2010

(54) LED-based lighting module for emitting white light with easily adjustable color temperature

(76) Inventor: Kai-Ming Yang, Taichung City (TW)

Correspondence Address: CHARLES E. BAXLEY, ESQUIRE, 90 JOHN STREET, SUITE 309, NEW YORK, NY, 10038, US

(21) Appl. No.: 12/384,144

(22) Filed: Apr. 1, 2009

(51) Int. Cl. F21V 9/00

(52) U.S. Cl. 362/231

(57) ABSTRACT

Disclosed is an LED white-light lighting module with an easily adjustable color temperature. The LED white-light lighting module includes a substrate, at least one red LED package, at least one green LED package, at least one blue LED package and a light tube. The red, green and blue LED packages are provided on the substrate. Each of the LED packages includes a plurality of scattering particles for providing preferred senses of direction of light so that red, green and blue light beams almost completely overlap to provide a white light beam. The light tube is transparent and contains the substrate.

### BACKGROUND OF INVENTION

1. Field of the Invention

The present invention relates to lighting modules and, more particularly, to an LED-based lighting module for emitting white light with easily adjustable color temperature.

2. Related Prior Art

A light-emitting diode (“LED”) is low in consumption of energy and high in efficiency of illumination. Therefore, a lot of efforts have been cast on LEDs for illumination.

Referring to FIG. 1, a conventional LED-based lighting module includes a red LED 1, a green LED 2 and a blue LED 3 connected to a circuit board 4. The circuit board 4 is connected to a terminal for connection to the mains or a socket of a lighting module. Red light, green light and blue light are mixed into white light. Wavelengths and intensities must be selected carefully. Therefore, the mixture is difficult, and white light only exists in a central zone where red, green and blue light beams overlap. The light turns to red, green and blue in areas away from the central zone. That is, there are color blocks.

Referring to FIG. 2, another conventional LED-based lighting module includes a red LED 1, a green LED 2 and a blue LED 3 connected to a circuit board 4. The circuit board 4 is connected to a terminal for connection to the mains or a socket of a lighting module. A lens 5 is located in front of the circuit board 4. The lens 5 is added with fluorescent powder 6 for mixing red light, green light and blue light into white light. However, the angle of the white light is limited. Moreover, the LEDs 1, 2 and 3 generate a lot of heat as a byproduct while emitting light. The fluorescent powder 6 is however vulnerable to heat and deteriorates with rising temperature so that there is serious optical decay.

Another conventional LED-based lighting module includes a white LED as a primary light source and red, green and blue LEDs for compensating the color temperature of light emitted from the white LED. That is, at least one of the red, green and blue LEDs is turned on and the intensity thereof is controlled to compensate the color temperature of the light emitted from the white LED when there is optical decay because of deteriorating of fluorescent powder used in the white LED. However, the color temperature cannot be compensated precisely. Moreover, the control over the intensity of an LED by the control over a current provided to the LED is difficult.

The present invention is therefore intended to obviate or at least alleviate the problems encountered in prior art.

### SUMMARY OF INVENTION

It is the primary objective of the present invention to provide an LED-based lighting module for emitting white light with easily adjustable color temperature.

To achieve the foregoing objective, the lighting module includes a substrate, at least three red light-emitting diode packages, at least three green light-emitting diode packages, at least three blue light-emitting diode packages and a transparent tube for containing the substrate. The light-emitting diode packages are provided on the substrate. Each of the red light-emitting diode packages includes a red light-emitting diode chip, a lens for wrapping the red light-emitting diode chip and scattering particles spread in the lens. Each of the green light-emitting diode packages includes a green light-emitting diode chip, a lens for wrapping the green light-emitting diode chip and scattering particles spread in the lens. Each of the blue light-emitting diode packages includes a blue light-emitting diode chip, a lens for wrapping the blue light-emitting diode chip and scattering particles spread in the lens.

Other objectives, advantages and features of the present invention will become apparent from the following description referring to the attached drawings.

### BRIEF DESCRIPTION OF DRAWINGS

The present invention will be described via detailed illustration of embodiments versus prior art referring to the drawings.

FIG. 1 is a cross-sectional view of a conventional LED-based lighting module.

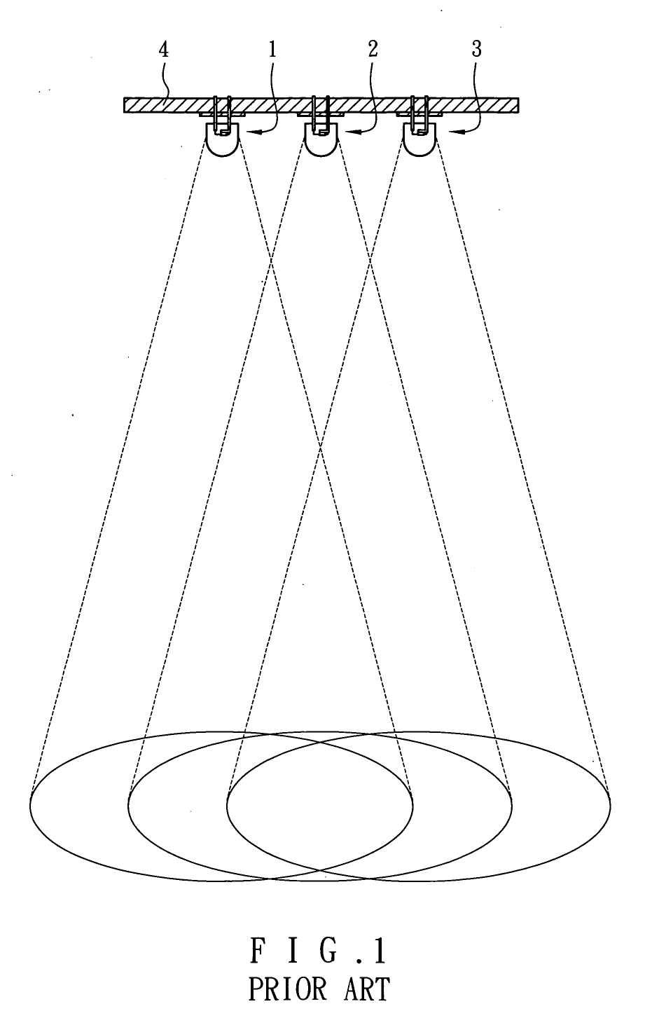

FIG. 2 is a cross-sectional view of another conventional LED-based lighting module.

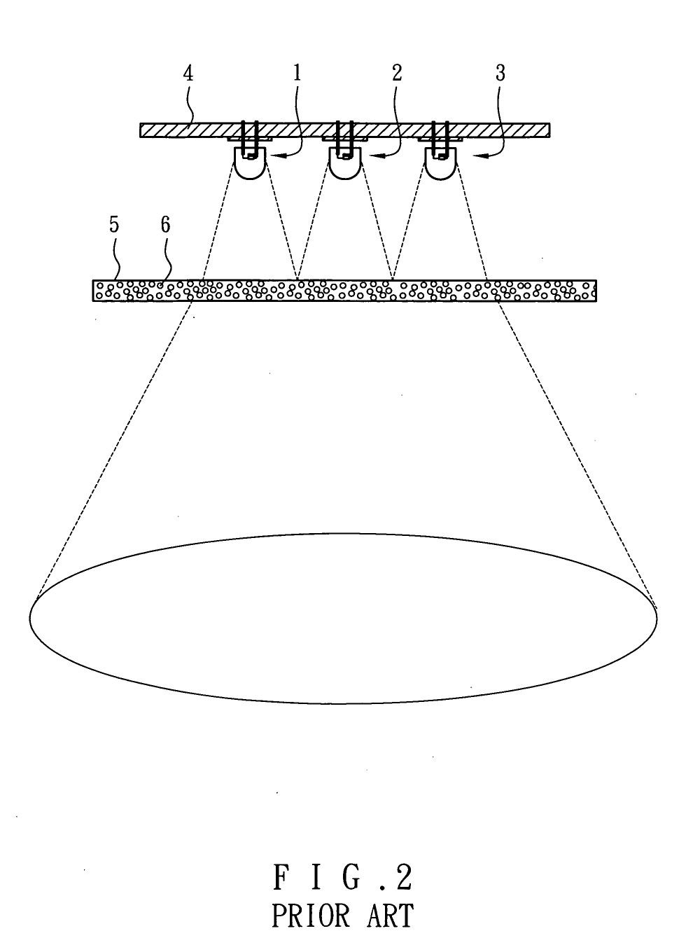

FIG. 3 is an exploded view of an LED-based lighting module according to a first embodiment of the present invention.

FIG. 4 is a cross-sectional view of the LED-based lighting module shown in FIG. 3.

FIG. 5 is another cross-sectional view of the LED-based lighting module of FIG. 3.

FIG. 6 is an exploded view of an LED-based lighting module according to a second embodiment of the present invention.

FIG. 7 is a cross-sectional view of the LED-based lighting module shown in FIG. 6.

FIG. 8 is a partial, perspective view of the LED-based lighting module of FIG. 6.

FIG. 9 is a bottom view of the LED-based lighting module shown in FIG. 8.

FIG. 10 is an exploded view of an LED-based lighting module according to a third embodiment of the present invention.

FIG. 11 is a cross-sectional view of the LED-based lighting module shown in FIG. 10.

### DETAILED DESCRIPTION OF PREFERRED EMBODIMENT

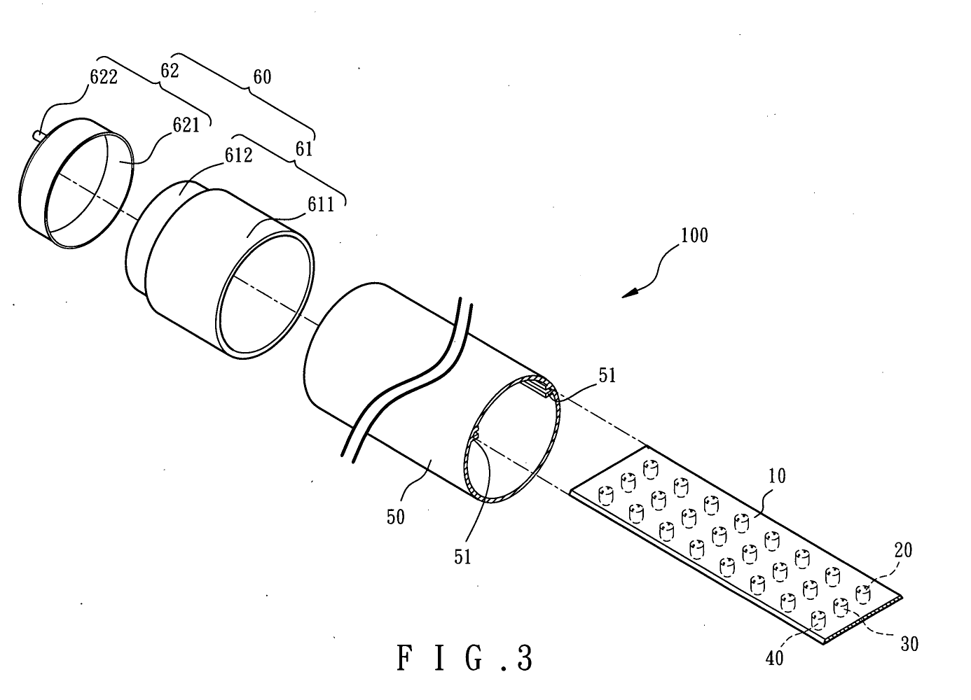

Referring to FIGS. 3 to 5, an LED-based lighting module 100 includes a substrate 10, red LED packages 20, green LED packages 30, blue LED packages 40, a transparent tube 50 and a conductive and connective device 60 according to a first embodiment of the present invention. The substrate 10 is a printed circuit board with predetermined wiring.

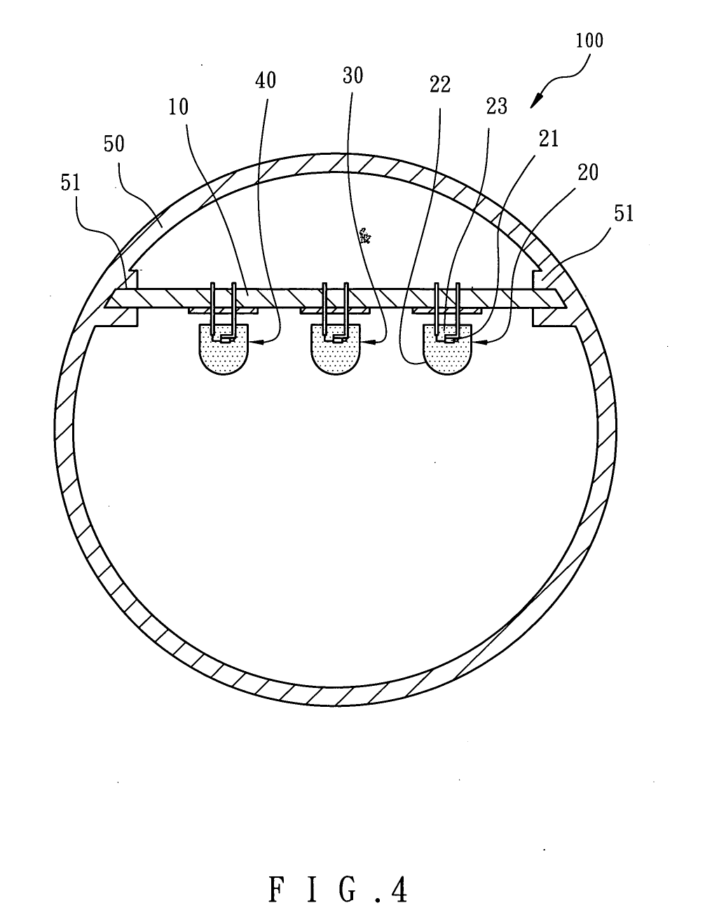

Referring to FIG. 4, each of the red LED packages 20 includes a red LED chip 21, a lens 22 and scattering particles 23. Given a certain current, the red LED chip 21 emits red light. The lens 22 is made of a transparent material such as epoxy, silicone and glass. The lens 22 is used to wrap the LED chip 21. The scattering particles 23 are scatter in the lens 22. The red LED packages 20 are provided on the substrate 10, in predetermined positions. The red LED packages 20 are electrically connected to the substrate 10 so that the former is actuated to emit red light with electricity from the latter.

Similarly, each of the green LED packages 30 includes a green LED chip, a lens and scattering particles. The GL LED packages 30 are located in predetermined positions on the substrate 10.

Similarly, each of the blue LED packages 40 includes a blue LED chip, a lens and scattering particles. The BL LED packages 40 are located in predetermined positions on the substrate 10.

The scattering particles used in the LED packages 20, 30 and 40 are made of at least one highly reflective or scattering material. For example, they can be made of silver, calcium carbonate (CaCO₃) and/or silicon dioxide (SiO₂), alone or in combination with resin.

The transparent tube 50 includes two grooves 51 defined in an internal side thereof. Each of the grooves 51 receives an edge of the substrate 10 so that the substrate 10 is kept in position in the transparent tube 50.

Referring to FIG. 3, the conductive and connective device 60 includes a collar 61 and a cap 62. The collar 61 includes a first section 611 and a reduced second section 612. The first section 611 of the collar 61 receives an end of the transparent tube 50 tightly because the internal diameter of the former is marginally larger than the external diameter of the latter. The cap 62 includes a cavity 621 for receiving the second section 612 of the collar 61 tightly because the internal diameter of the former is marginally larger than the external diameter of the latter. Two pins 622 are inserted through the cap 62, i.e., each of the pins 622 is formed with a first end for electric connection to the substrate 10 and a second end for electric connection to a socket of the mains for example. Thus, electricity can be provided to the LED packages 20, 30 and 40 from the mains through the pins 622 and the substrate 10.

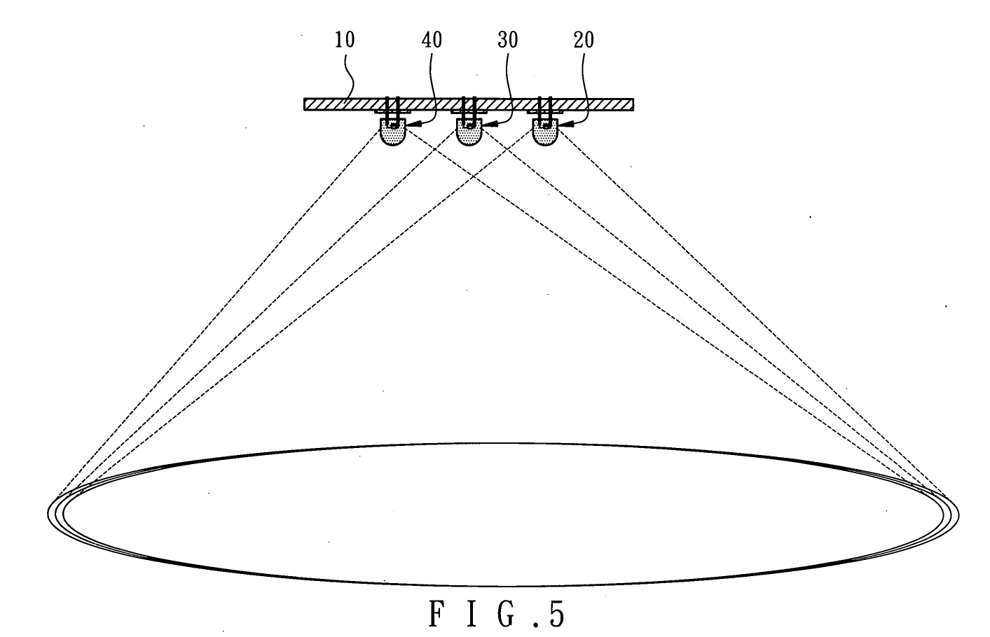

Referring to FIG. 5, the red LED packages 20 emit red light beams. The green LED packages 30 emit green light beams. The blue LED packages 40 emit blue light beams. The numbers and positions of the scattering particles disposed in the lens of each of the LED packages 20, 30 and 40 is carefully determined so that the scattering particles cause the LED packages 20, 30 and 40 to cast similar light beams that almost completely overlap one another, leaving small color blocks. The color blocks are too small to be observed by humans. That is, the red light, the green light and the blue light are well mixed into white light. The numbers and positions of the scattering particles respectively used in the LED packages 20, 30 and 40 are different from one another.

The substrate 10 is a printed circuit board in the first embodiment. However, the substrate 10 may be an isolating plate and the LED packages 20, 30 and 40 are connected to one another with jumpers.

Moreover, the LED chips 21, 31 and 41 are packaged independent of one another. Hence, the heat radiation of the lighting module 100 is better than that of a conventional lighting module with LED chips packaged in a common lens.

Furthermore, since there are several red LED packages 20, several green LED packages 30 and several blue LED packages 40 on the substrate 10, they can be replaced with one another or their positions can be changed to adjust the color temperature from cold to warm. For example, color temperature for indoor use can be different from color temperature for outdoor use. The color temperature of the light emitted from the lighting module 100 can easily be adjusted without having to use a complicated mechanism to change currents or voltages provided to the LED packages.

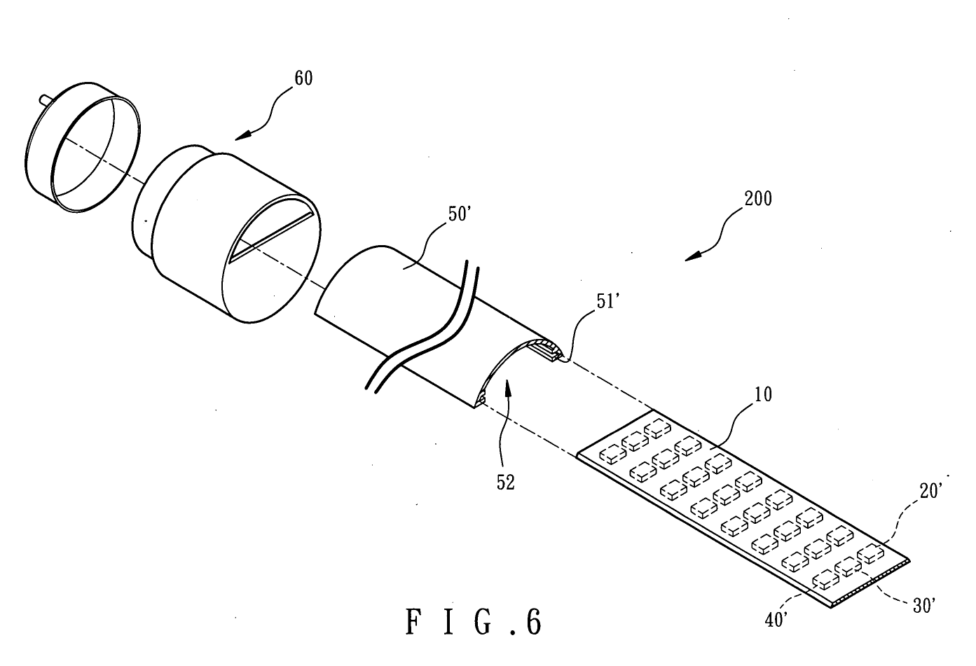

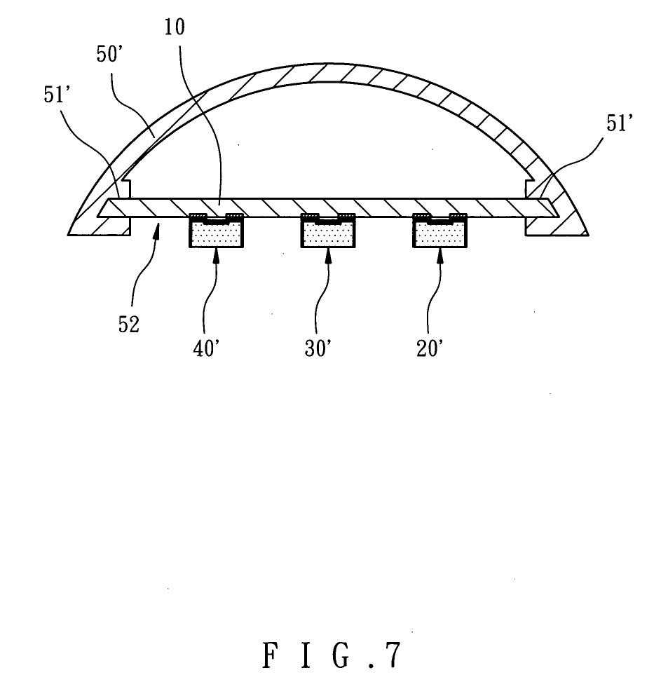

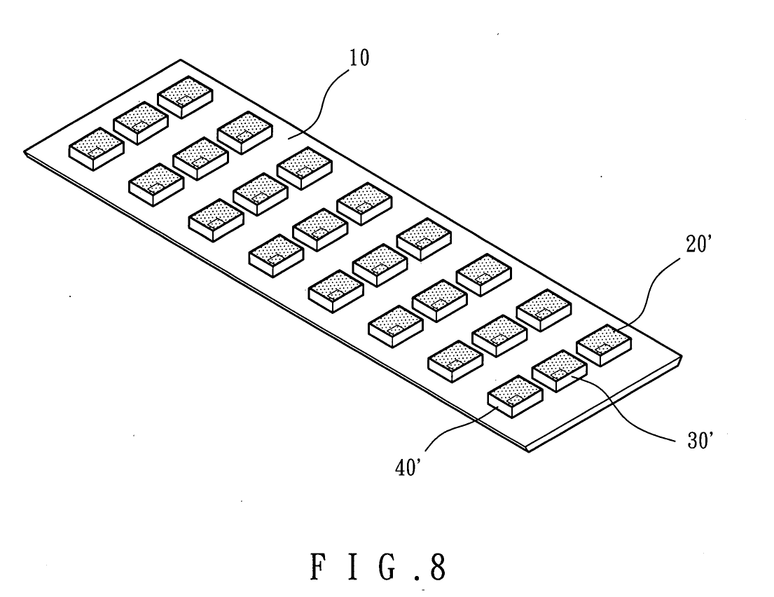

Referring to FIGS. 6 through 8, there is shown a lighting module 200 according to a second embodiment of the present invention. The lighting module 200 is like the lighting module 100 except two things. Firstly, LED packages 20′, 30′ and 40′ are used instead of the LED packages 20, 30 and 40, respectively. The LED packages 20′, 30′ and 40′ are surface mount device LED packages while the LED packages 20, 30 and 40 are LED lamp-typed. That is, the LED packages 20′, 30′ and 40′ are attached to the substrate 10 different than the LED packages 20, 30 and 40 are attached to the substrate 10.

Secondly, a hemi-tube 50′ is used instead of the transparent tube 50. The hemi-tube 50′ includes an opening 52. The light emitted from the LED packages 20′, 30′ and 40′ is cast through the opening 52, without being shielded with anything. Therefore, the LED-based lighting module 200 emits brighter light than the LED-based lighting module 100.

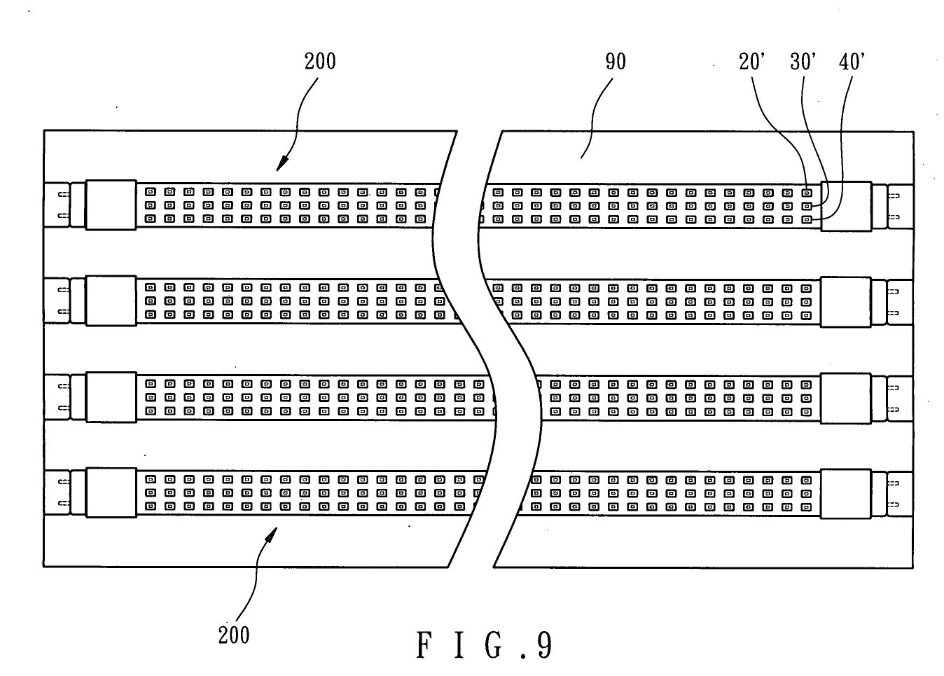

Referring to FIG. 9, three LED-based lighting modules 200 are used in a same object 90. Very bright light can be emitted from the object 90 because there are more than one LED-based lighting module 200 and the light emitted from the LED-based lighting modules 200 are not shielded with anything.

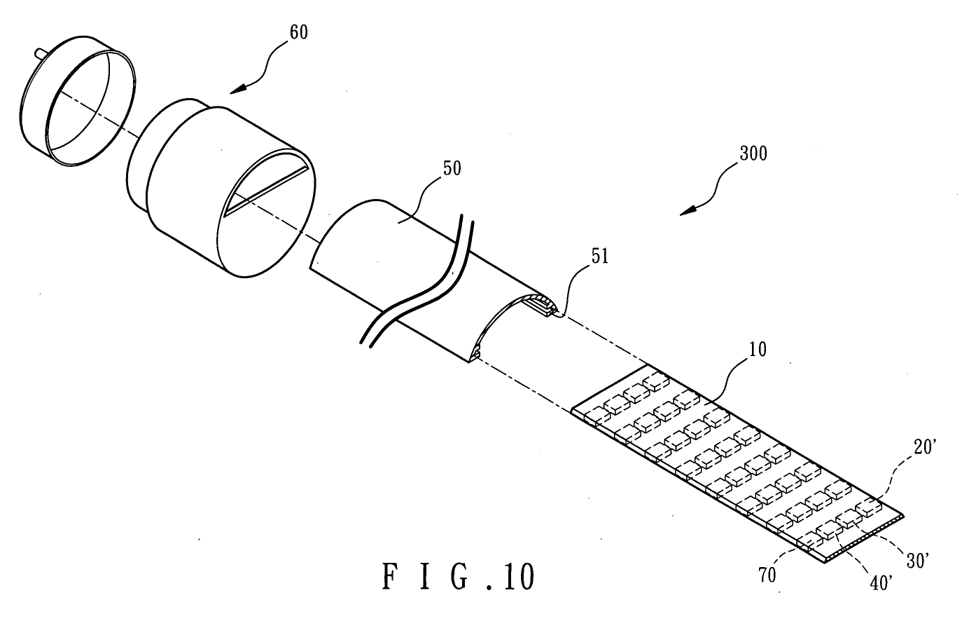

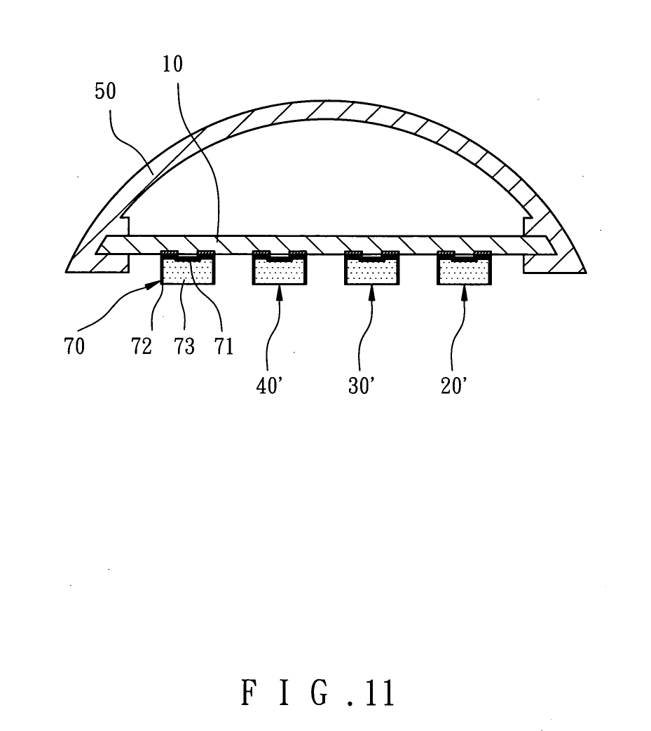

Referring to FIGS. 10 and 11, there is shown a lighting module 300 according to a third embodiment of the present invention. The lighting module 300 is like the lighting module 200 except including additional LED packages 70 to emit a fourth color of light. Like the LED packages 20′, 30′ and 40′, each of the LED packages 70 includes an LED chip 71, a lens 72 and scattering particles 73.

The LED packages 70 may emit light with a wavelength of 560 nm to 610 nm. Light with a wavelength of 560 nm to 610 nm is yellow light. Yellow light is mixture of red light with green light. Yellow light can be mixed with blue light into white light.

Alternatively, the LED packages 70 may emit light with a wavelength of 470 nm to 500 nm. Light with a wavelength of 470 nm to 500 nm is bluish green light.

The numbers of the LED packages can be reduced by increasing the power of the LED packages to 1 watt for example.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A lighting module comprising:
a substrate;
at least three red light-emitting diode packages, at least three green light-emitting diode packages and at least three blue light-emitting diode packages provided on the substrate and each formed with a light-emitting diode chip, a lens for wrapping the light-emitting diode chip and scattering particles spread in the lens; and
a transparent tube for containing the substrate.

2. The lighting module according to claim 1 comprising:
a collar comprising a first section for receiving an end of the transparent tube and a second section; and
a cap for receiving the second section of the collar; and
two pins extended through the cap and each formed with an end electrically connected to the substrate.

3. The lighting module according to claim 1, wherein the substrate is a printed circuit board.

4. The lighting module according to claim 1, wherein the substrate is an isolating plate, and the light-emitting diode packages are connected to one another with jumpers.

5. The lighting module according to claim 1, wherein the lenses are made of a material selected from a group consisting of epoxy, silicone and glass.

6. The lighting module according to claim 1, wherein the scattering particles are made of a material selected from a group consisting of a highly reflective material and a highly scattering material.

7. The lighting module according to claim 1, wherein the scattering particles are made of at least one material selected from a group consisting of silver, calcium carbonate, silicon dioxide and resin.

8. The lighting module according to claim 1, wherein the numbers and positions of the scattering particles respectively spread in the lenses of the red, green and blue light-emitting diode packages are different from one another.

9. The lighting module according to claim 1, wherein the transparent tube comprises two grooves defined therein for receiving two edges of the substrate.

10. The lighting module according to claim 1, wherein the red light-emitting diode packages are light-emitting diode lamps.

11. The lighting module according to claim 1, wherein the green light-emitting diode packages are light-emitting diode lamps.

12. The lighting module according to claim 1, wherein the blue light-emitting diode packages are light-emitting diode lamps.

13. The lighting module according to claim 1, wherein the red light-emitting diode packages are surface-mount devices.

14. The lighting module according to claim 1, wherein the green light-emitting diode packages are surface-mount devices.

15. The lighting module according to claim 1, wherein the blue light-emitting diode packages are surface-mount devices.

16. The lighting module according to claim 1 comprising a plurality of fourth-color light-emitting diode packages.

17. The lighting module according to claim 16, wherein the fourth-color light-emitting diode packages are light-emitting diode lamps.

18. The lighting module according to claim 16, wherein the fourth-color light-emitting diode packages are surface-mount devices.

19. A lighting module comprising:
a substrate;
at least three red light-emitting diode packages, at least three green light-emitting diode packages and at least three blue light-emitting diode packages provided on the substrate and each formed with a light-emitting diode chip, a lens for wrapping the light-emitting diode chip and scattering particles spread in the lens; and
a hemi-tube for supporting the substrate.
